(19) United States
(12) Patent Application Publication
(10) Pub. No.: US 2022/0199002 A1
(43) Pub. Date: Jun. 23, 2022

(54) COMPENSATED CURRENT MIRROR CIRCUIT

(71) Applicants: Imec vzw, Leuven (BE); Katholieke Universiteit Leuven, KU LEUVEN R&D, Leuven (BE)

(72) Inventors: Lynn Verschueren, Bertem (BE); Kris Myny, Heusden-Zolder (BE); Jan Genoe, Testelt (BE); Wim Dehaene, Kessel-Lo (BE)

(21) Appl. No.: 17/554,929

(22) Filed: Dec. 17, 2021

(30) Foreign Application Priority Data
Dec. 18, 2020 (EP) 20215459.7

(51) Int. Cl. G09G 3/32

(52) U.S. Cl. CPC G09G 3/32; G09G 2320/0626

(57) ABSTRACT

A compensated current mirror circuit comprises a current mirror with a primary current path and a secondary current path, configured to mirror a current through the primary current path to the secondary current path. The current is settable by switching a reference current through a reference current line into the primary current path. A primary current mirror transistor is connected in series with the primary current path. A secondary current mirror transistor is connected in series with the secondary current path. A gate of the primary current mirror transistor is connected to a gate of the secondary current mirror transistor at a current mirror node. A compensation block is connected to a back gate of the secondary current mirror transistor and to one or more compensation control lines, and is configured to apply a compensation signal at the back gate based on the compensation control lines.

### CROSS-REFERENCE TO RELATED APPLICATIONS

The present application is a non-provisional patent application claiming priority to European Patent Application No. 20215459.7, filed Dec. 18, 2020, the contents of which are hereby incorporated by reference.

### FIELD OF THE DISCLOSURE

The application relates to a compensated current mirror circuit, for example, in the form of a pixel circuit for driving a light-emitting diode (LED), a system comprising the compensated mirror circuit, and to a method for controlling the same.

### BACKGROUND

Current mirror circuits are used in many applications, for example, as pixel circuits in a display. Current mirror circuits facilitate the setting of a current in a secondary current path by inputting a reference current in a primary current path.

Displays comprising various types of LEDs, such as perovskite LEDs (PeLEDs), mini-LEDs, and micro-LEDs, which may be thin-film LEDs, are growing increasingly popular. It is desirable for such a display to offer accurate color reproduction, while still allowing for accurate control of the display brightness. Moreover, the uniformity of such a display depends on an accurate setting of the pixel current.

### SUMMARY

Aspects described herein provide a current mirror circuit, for example, for use as a pixel circuit, allowing for accurate current setting.

According to a first aspect, there is provided a compensated current mirror circuit, comprising a current mirror. The current mirror comprises a primary current path and a secondary current path, configured to mirror a current through the primary current path to the secondary current path. The current through the primary current path is settable by switching a reference current through a reference current line into the primary current path. The current mirror comprises a primary current mirror transistor connected in series with the primary current path, and a secondary current mirror transistor connected in series with the secondary current path. A gate of the primary current mirror transistor is connected to a gate of the secondary current mirror transistor at a current mirror node. The compensated current mirror circuit further comprises a compensation block connected to a back gate of the secondary current mirror transistor and to one or more compensation control lines. The compensation block is configured to apply a compensation signal to the back gate of the secondary current mirror transistor based on the one or more compensation control lines.

For example, the compensated current-mirror circuit may be configured to function as a pixel circuit in a display. Many types of LEDs, both of a thin-film type, and LEDs typically used for high brightness applications exhibit wavelength shift when different currents are applied, shifting the color point of the display of which the LED forms part. Driving a fixed current through the LED using the current mirror mitigates this problem.

However, accurate setting of the current through the secondary current path, in the above pixel circuit example or otherwise, by switching the reference current to the primary current path conventionally requires accurate matching of the characteristics of the primary current mirror transistor and the secondary current mirror transistor. Differences between the primary current mirror transistor and the secondary current mirror transistor may, for example, be due to process variations.

Applying a compensation signal to the back gate of the secondary current mirror transistor based on the one or more compensation control lines facilitates compensation for such a mismatch by shifting the V_{T} (threshold voltage) of the secondary current mirror transistor. Thereby, the current through the secondary current path may be better controlled, providing, for example, for a more uniform display.

According to an embodiment, the compensation block comprises a compensation selection transistor and a capacitor. The compensation transistor is connected between a compensation data line and the back gate of the secondary current mirror transistor and is controlled by a compensation selection line. A first terminal of the capacitor is connected at a point between the compensation selection transistor and the back gate of the secondary current mirror transistor.

This facilitates particularly efficient routing of the compensation signal to the switch component.

According to an embodiment, a second terminal of the capacitor is connected to a voltage source.

This configuration facilitates charging of the capacitor via the compensation signal.

According to an embodiment, the compensated current mirror circuit further comprises a first current-setting transistor controlled by a current selection line and connected between the primary current path and the reference current line, a second current-setting transistor controlled by the current selection line and connected between the current mirror node and the primary current path, and a capacitor connected at the current mirror node.

This allows for a particularly efficient arrangement for setting the current of the current mirror.

According to an embodiment, the compensated current mirror circuit further comprises a switch component configured to switch a load to and from the secondary current path based on one or more switch control lines.

The switch component, which allows the switching of a load, such as a LED, to and from the secondary current path of the current mirror, allows for switching the load on and off with a time modulation, such as pulse-width modulation. Thereby, for example, the apparent brightness of the LED in the pixel may be accurately controlled, while keeping a constant current through the LED when the LED is turned on. Thus, in the case of driving a display, the present compensated current mirror circuit (pixel circuit) further allows for accurate pixel brightness control, while retaining accurate color characteristics.

According to an embodiment, the switch component is a switch transistor connected in series with the secondary current path and the load and is controlled based on the one or more switch control lines.

This is a particularly simple way of arranging the switch component.

According to an embodiment, the one or more switch control lines comprise a switch selection line and a switch data line. In an example of this embodiment, the compensated current mirror circuit further comprises a switch selection transistor and a capacitor. The switch selection transistor is connected between the switch data line and the switch component and is controlled by the switch selection line. A first terminal of the capacitor is connected at a point between the switch selection transistor and the switch transistor.

This allows for particularly efficient routing of a time modulation signal to the switch component.

According to an embodiment, there is provided a pixel circuit for driving a light-emitting diode, LED, comprising the compensated current mirror circuit according to the above, wherein the secondary current path is configured to drive the LED.

This is a particularly beneficial application of the compensated current-mirror circuit.

According to an embodiment, the LED is a PeLED, a mini-LED, or a micro-LED.

According to a second aspect, there is provided a system comprising a plurality of compensated current mirror circuits or pixel circuits of any one of the preceding claims, and a calibration block configured to apply a compensation signal at the one or more compensation control lines.

This aspect may generally present the same or corresponding features as the former aspect. Embodiments and features described above in conjunction with the first aspect and throughout this disclosure are compatible with this second aspect.

According to an embodiment, the calibration block is configured to apply the compensation signal for matching transistor characteristics between the primary current mirror transistor and the secondary current mirror transistor.

According to a third aspect, there is provided a method for controlling a compensated current mirror circuit for driving a load, such as a light-emitting diode, LED. The method comprises setting a current for driving the load, such as an LED, by switching a reference current to a primary current path of a current mirror configured to mirror a current of the primary current path to a secondary current path. The method further comprises applying a compensation signal to a back gate of a secondary current mirror transistor of the secondary current path.

This aspect may generally present the same or corresponding features as the former aspect. Embodiments and features described above in conjunction with the first aspect, and throughout this disclosure, are compatible with this third aspect.

According to an embodiment, the method further comprises connecting the load to the secondary current path based on a pulse-width-modulated, PWM, control signal.

### BRIEF DESCRIPTION OF THE FIGURES

The above, as well as additional features, will be better understood through the following illustrative and non-limiting detailed description of example embodiments, with reference to the appended drawings. In the drawings like reference numerals will be used for like elements unless stated otherwise.

FIG. 1 shows a compensated current mirror circuit, in accordance with example embodiments.

FIG. 2 shows a compensated current mirror circuit, in accordance with example embodiments.

FIG. 3 shows a system comprising a compensated current mirror circuit, in accordance with example embodiments.

All the figures are schematic, not necessarily to scale, and generally only show parts that are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

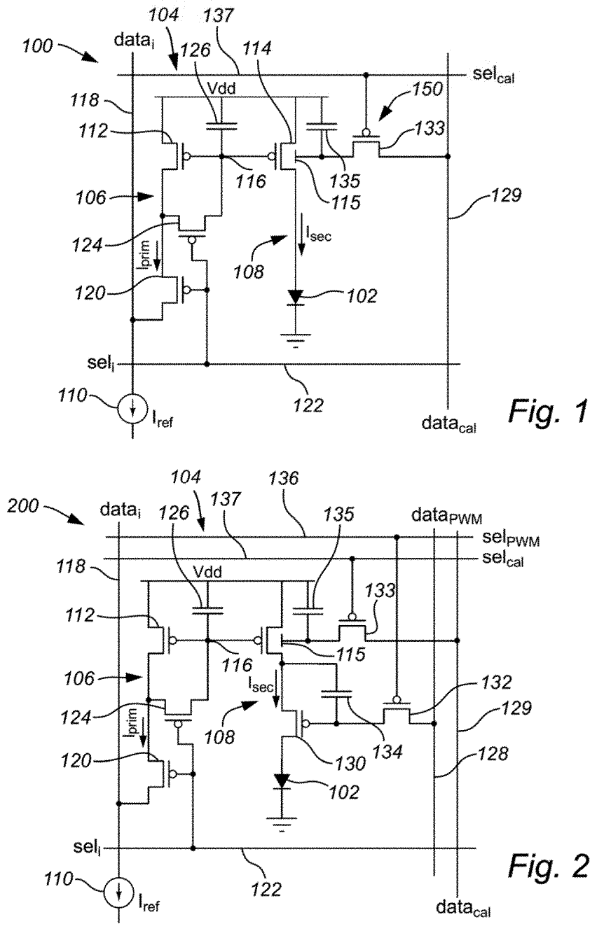

FIG. 1 shows a compensated current-mirror circuit 100. In the example of FIG. 1, the compensated current-mirror circuit 100 is configured as a pixel circuit configured for driving a light-emitting diode (LED) 102, although other applications are equally possible.

The compensated current-mirror circuit 100 comprises a current mirror 104. The current mirror comprises a primary current path 106 and a secondary current path 108 and is configured so that a current Iprim through the primary current 106 path is mirrored, i.e., replicated, as a current Isec through the secondary current path 108, as will be explained in the following.

As shown, the primary current path 106 may run from a supply voltage Vdd and to a reference current source 110. The secondary current path may run between the supply voltage Vdd and ground.

In the specific example shown with the compensated current-mirror circuit being configured as a pixel circuit driving a LED, the LED 102 may be connected in series with the secondary current path 108, the secondary current path 108 thereby being configured to drive the LED 102, which may, for example, be a perovskite LED (PeLED), a mini-LED, or a micro-LED. Further, or additionally, the LED may, for example, be a thin-film LED. Generally, the LED may be replaced by some other load driven by the secondary current path 108.

As shown, the current mirror 104 comprises a primary current mirror transistor 112 connected in series with the primary current path 106. For example, as shown, one terminal of primary current mirror transistor 112, which may be a source terminal or a drain terminal, may be connected to the supply voltage Vdd, with the primary current path 106 running through the primary current mirror transistor 112 from the before mentioned terminal to another terminal of the primary current mirror transistor 112, which may be the other of the source terminal or the drain terminal of that transistor. Further, a gate terminal of the primary current mirror transistor 112 is connected to a current mirror node 116.

Further, and similarly, the current mirror 104 comprises a secondary current mirror transistor 114 connected in series with the secondary current path 108. For example, as shown, one terminal of secondary current mirror transistor 114, which may be a source terminal or a drain terminal, may be connected to the supply voltage Vdd, with the secondary current path 108 running through the secondary current mirror transistor 114 from the mentioned terminal to another terminal of the secondary current mirror transistor 114, which may be the other of the source terminal or the drain terminal of that transistor. Further, a gate terminal of the secondary current mirror transistor 114 is connected to the current mirror node 116.

The gate terminals of the primary current mirror transistor 112 and the secondary current mirror transistor 114 being connected at the current mirror node 116 allows for the current mirror 104 to mirror the current Iprim of the primary current path 106 in the current Isec through the secondary current path 108.

Still with reference to FIG. 1, the pixel circuit 100 is connectable to a reference current line dataᵢ 118, where a reference current source 110 is connected in series in and with the reference current line 118.

The current Iprim through the primary current path 106 is settable by switching the reference current Iref through reference current line 118 into the primary current path 106.

For example, as shown in FIG. 1, the pixel circuit 100 may comprise a first current-setting transistor 120. The gate terminal of the first current-setting transistor 120 is connected to a current-selection line selᵢ 122, which thereby controls the first current-setting transistor 120. Moreover, two other terminals of the first current-setting transistor 120, which may be source and drain terminals, are connected between the primary current path 106 and the reference current line 118, i.e., in series with both. Thus, through a signal, e.g., a high state on the current-selection line 122, the first current-setting transistor 120 becomes conductive between the source and drain terminals, so that the reference current I_{ref} through reference current line 118 is switched into the primary current path 106.

Further, still with reference to FIG. 1, the pixel circuit 100 may comprise a second current-setting transistor 124. The gate terminal of the second current-setting transistor 124 is connected to the current-selection line selᵢ 122, which thereby controls the second current-setting transistor 124.

Moreover, two other terminals of the second current-setting transistor 124, which may be source and drain terminals, are connected between the current mirror node 116 and the primary current path 106, at a point between the primary current-mirror transistor 112 and the first current-setting transistor 120. Thus, through a signal, e.g., a high state on the current selection line 122, the second current-setting transistor 124 becomes conductive between the source and drain terminals, so that a capacitor 126, connected between the supply voltage V_{dd} and the current mirror node 116 may be charged to a value corresponding to the current mirror 104 mirroring the reference current, as will be explained further below.

However, the skilled person could equally contemplate other current arrangements for switching the reference current I_{ref} through reference current line 118 into the primary current path 106, as known per se.

In the specific example of the compensated current mirror circuit 100 being a pixel circuit, typically, the pixel circuits of a display may be configured in a two-dimensional grid, for example, a rectangular or quadratic grid, wherein the pixels of a specific row of the grid may be connected to the same current-selection line 122, while the pixels of a specific column of the grid may be connected to the same reference current line 118.

Differently stated, in the pixel circuit 100, the primary current-mirror transistor 112 and the secondary current-mirror transistor 114 define the current mirror 104. The first current-setting transistor 120 and the second current-setting transistor 124 function as selection transistors, which may, in the specific example of the compensated current-mirror circuit being a pixel circuit, select to which row of pixels a reference current line 118 applies. The current through the primary current mirror transistor is set to be equal to the reference current by storing an appropriate charge on the capacitor 126 connected at the current mirror node 116 to the gate terminals of the primary current-mirror transistor 112 and the secondary current-mirror transistor 114.

When the current-selection line 122 is active, the first current-setting transistor 120 is conducting, for example, for all pixels in the corresponding row, and thus the respective reference current lines 118 are active for that row. The reference current line 118 in each respective column is then connected to the drain and gate of the primary current-mirror transistor 112. Then, the reference current I_{ref}, flowing through the reference current line 118, can flow through the first current-setting transistor 120 and either the second current-setting transistor 124—for changing the charge on the capacitor 126—or through the primary current-mirror transistor 112 towards the supply voltage V_{dd}. When the charge on the capacitor 126 reaches the appropriate amount for mirroring the reference current, the current through the primary current-mirror transistor 112 will be equal to the reference current I_{ref}, and hence there will be no current through the second current-setting transistor 124, retaining the appropriate charge on the capacitor 126.

Since the primary current-mirror transistor 112 and the secondary current-mirror transistor 114 are configured to define the current mirror 104, the current I_{sec} flowing through the secondary current-mirror transistor 114 will be proportional to the current flowing through the primary current-mirror transistor 112, with a fixed proportionality ratio, depending on the characteristics of the transistors 112, 114 and which may be determined through matching of the primary current-mirror transistor 112 and the secondary current-mirror transistor 114. Hence, the current I_{sec} that will flow through the secondary current-mirror transistor 114, and thereby through its load, such as through the LED 102, may be accurately set.

When the current-selection line 122 is deactivated, the first current-setting transistor 120 and the second current-setting transistor 124 will no longer be conducting between their respective source and drain terminals. Hence, the charge on the capacitor 126 will remain. Since the terminal is not connected to the supply voltage V_{dd} or the current-mirror node 116 of the primary current-mirror transistor 112 thereby will be floating, no current will longer flow through the primary current-mirror transistor 112 in the primary current path 106. However, since an appropriate charge is still stored on the capacitor 126, leading to an appropriate voltage at the current-mirror node 116, and thus at the gate terminal of the secondary current-mirror transistor 114, an appropriate current, as set according to the above, will flow through the secondary current-mirror transistor 114 in the secondary current path 108.

The secondary current-mirror transistor 114 is a dual-gate transistor comprising a back gate 115, as known per se.

Still with reference to FIG. 1, the compensated current-mirror circuit 100 further comprises a compensation block 150 as will be explained in the following.

In the simplest case (not shown), the compensation block 150 may simply comprise the routing of a compensation line to the back gate 115 of the secondary current-mirror transistor 114, so that compensation block 150 is configured to apply a compensation signal on the compensation line to the back gate 115 of the secondary current mirror transistor 114.

However, the compensation control lines may also, as shown in FIG. 1, comprise a compensation selection line sel_{cal} 137 and a compensation data line data_{cal} 129. Further, the compensation block 150 may comprise a compensation selection transistor 133 connected through two terminals, which may be source and drain terminals, between the compensation data line 129 and the back gate terminal 115 of the secondary current mirror transistor 114. Further, the gate terminal of the compensation selection transistor 133 may be connected to the compensation selection line 137, the compensation selection transistor 133 thereby being controlled by the compensation selection line 137.

In the specific example of the compensated current mirror circuit 100 being a pixel circuit, with, as per the above, the pixel circuits of the display being configured in a two-dimensional grid, the pixels of a specific row of the grid may be connected to the same compensation selection line 137, while the pixels of a specific column of the grid may be connected to the same compensation data line 129.

Hereby, through a signal, e.g., a high state, on the compensation selection line 137, the compensation selection transistor 133 becomes conductive between the compensation data line 129 and the back gate 115 of the secondary current mirror transistor 114, so that a compensation signal from the compensation data line 129 may be applied at the back gate 115.

The compensation block 150 may further comprise a capacitor 135, wherein a first terminal of the capacitor 135 is connected at a point between the compensation selection transistor 133 and the back gate 115 the secondary current mirror transistor 114. Further, as shown, a second terminal of the capacitor 135 may be connected to the supply voltage V_{dd}, and thereby to a voltage source. Hereby, through charging of the capacitor 135, the compensation data signal as carried by the compensation data line 129 is persistent when the compensation selection line 137 goes low.

Thus, the compensation block 150 is connected to the back gate 115 of the secondary current-mirror transistor 114 and to the compensation selection line sel_{cal} 137 and the compensation data line data_{cal} 129 and is configured to apply a compensation signal to the back gate 115 of the secondary current mirror transistor 114 based on the one or more compensation control lines.

The voltage thereby applied on the back gate 115 of the secondary current mirror transistor 114 shifts the VT of the secondary current-mirror transistor 114 and hence, may compensate for mismatch in the characteristics of the primary current mirror transistor 112 and the secondary current-mirror transistor 114.

In other words, the compensation selection transistor 133 may be used as a select transistor to pass a compensation signal to the back gate 115 of the secondary current mirror transistor 114. By changing the voltage on the back gate 115, the VT of that transistor, which may be a thin-film transistor (TFT), will shift. Hence, by applying an appropriate voltage on the back gate 115 of the secondary current mirror transistor 115, the VT of that transistor can be shifted, and thus the difference between the current through the primary current mirror transistor and the current through the secondary current mirror transistor may be significantly reduced.

FIG. 2 shows an alternative compensated current-mirror circuit 200.

The compensated current-mirror circuit 200 has the same structure and features as the compensated current-mirror circuit 100 disclosed above in conjunction with FIG. 1, with the following differences.

The compensated current mirror circuit 200 comprises a switch component, for example, as shown in FIG. 2, a switch transistor 130, configured to switch the LED 102 to and from the secondary current path 108 based on one or more switch control lines.

The switch transistor 130 may, as shown, through two terminals, which may be source and drain terminals, be connected in series with the secondary current path 108, between the secondary current-mirror transistor 14 and the LED 102 (or some other load). In the simplest case (not shown), the switch transistor 130 may, at its gate terminal, be directly connected to a single switch control line, thereby being controlled by the same.

However, the switch control lines may also, as shown in FIG. 2, comprise a switch selection line sel_{PWM} 136 and a switch data line data_{PWM} 128. Further, the compensated current mirror circuit 200 may comprise a switch selection transistor 132 connected through two terminals, which may be source and drain terminals, between the switch data line 128 and the gate terminal of the switch transistor 130. Further, the gate terminal of the switch selection transistor 132 may be connected to the switch selection line 136, the switch selection transistor 132 thereby being controlled by the switch selection line 136.

Hereby, through a signal, e.g., a high state, on the switch selection line 136, the switch selection transistor 132 becomes conductive between the switch data line 128 and the gate terminal of the switch transistor 130, so that the switch transistor 130 may be controlled by the switch data line 128.

Further, still with reference to FIG. 2, the compensated current mirror circuit 200 may comprise a capacitor 134, where a first terminal of the capacitor 134 is connected at a point between the switch selection transistor 132 and the switch transistor 130 and a second terminal of the capacitor 134 is connected to the secondary current path 108, for example, as shown, at a point between the secondary current-mirror transistor 114 and the switch transistor 130. Hereby, through charging of the capacitor 134, the switch data signal as carried by the switch data line 128 is persistent when the switch selection line 136 goes low.

In the specific example of the compensated current mirror circuit 200 being a pixel circuit, with, as per the above, the pixel circuits of the display being configured in a two-dimensional grid, the pixels of a specific row of the grid may be connected to the same switch selection line 136, while the pixels of a specific column of the grid may be connected to the same switch data line 128.

In other words, the switch transistor 130 and the switch selection transistor 132 may be used as switches, whereby the switch selection transistor 132 is used as a selection transistor to pass a switch signal, as input on the switch data line 128 to the gate terminal of the switch transistor 130 of a desired current mirror circuit. Through time modulation of the switch signal, the switch transistor 130 may determine an average light intensity of the LED 102 (and thus the brightness) through connecting or disconnecting the LED 102 (or correspondingly for some other load) and the current mirror, depending on the switch signal.

For example, the time modulation of the switch signal may comprise pulse-width modulation, PWM, as known per se.

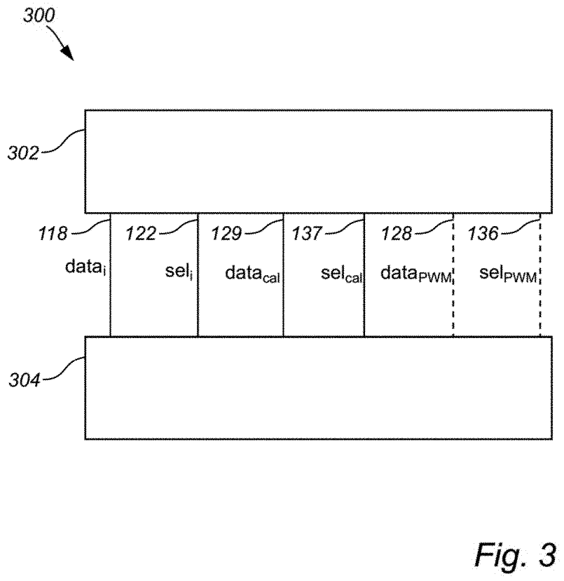

FIG. 3 shows, schematically, a system 300 comprising a control block 302 and a display backplane 304, where the display backplane 304 comprises a plurality of compensated current-mirror circuits 100, 200, in this example in the form of pixel circuits, as per the above. The control block 302 is connected to the display backplane 304 through a plurality of reference current lines 118, a plurality of current-selection lines 122, a plurality of compensation data lines 129, a plurality of compensation selection lines 137. Further, optionally, in case the compensated current-mirror circuits 200 of the display backplane 304 are of the kind disclosed above in conjunction with FIG. 2, the control block 302 may further be connected to the backplane 304 through a plurality of switch data lines 128 and a plurality of switch selection lines 136. For the plurality of reference current lines, the control block 302 may comprise the reference current source 110 (cf. FIGS. 1, 2).

One or more pixel circuits of the display backplane 304 may be controlled in a method comprising setting a current for driving a load, such as the LED 102, by the control block 302, through a reference current line 118 and a current-selection line 122, switching a reference current into the primary current path 106 of the current mirror 104 configured to mirror a current of the primary current path 106 to the secondary current path 108. This may be performed by a scanning procedure, putting the selection line of respective successive rows of the display backplane 304 high and inputting appropriate reference currents on the reference current lines for the pixels in each column of that row.

Further, through a compensation data line 129 and a compensation selection line 137, the control block 302, functioning as a calibration block, may apply a compensation signal to a back gate 115 of a secondary current mirror transistor 114, for current matching between the primary current mirror transistor 112 and the secondary current mirror transistor 114, as described above. This, too, may be performed by a scanning procedure, putting the compensation selection line of respective successive rows of the display backplane 304 high and inputting appropriate compensation signals of the compensation data lines 129 for the pixels in each column of that row.

Further, the control block 302 may signal the connecting of a load, such as an LED 102, connected to the secondary current path 108 using a switch data line 128 and a switch selection line 136. This signaling of the control block 302 may comprise applying a time modulation, such as pulse-width modulation, PWM, at those control lines. This, too, may be performed by a scanning procedure, putting the switch selection line of respective successive rows of the display backplane 304 high and inputting appropriate switch data, possibly as time modulated, on the switch data lines for the pixels in each column of that row.

While some embodiments have been illustrated and described in detail in the appended drawings and the foregoing description, such illustration and description are to be considered illustrative and not restrictive. Other variations to the disclosed embodiments can be understood and effected in practicing the claims, from a study of the drawings, the disclosure, and the appended claims. The mere fact that certain measures or features are recited in mutually different dependent claims does not indicate that a combination of these measures or features cannot be used. Any reference signs in the claims should not be construed as limiting the scope.

What is claimed is:

1. A compensated current mirror circuit, comprising:
a current mirror comprising a primary current path and a secondary current path configured to mirror a current through the primary current path to the secondary current path, wherein the current through the primary current path is settable by switching a reference current through a reference current line into the primary current path, wherein the current mirror comprises:
a primary current mirror transistor connected in series with the primary current path; and
a secondary current mirror transistor connected in series with the secondary current path,
wherein a gate of the primary current mirror transistor is connected to a gate of the secondary current mirror transistor at a current mirror node,
wherein the compensated current mirror circuit further comprises:
a compensation block connected to a back gate of the secondary current mirror transistor and to one or more compensation control lines, wherein the compensation block is configured to apply a compensation signal to the back gate of the secondary current mirror transistor based on the one or more compensation control lines.

2. The compensated current mirror circuit of claim 1, wherein the compensation block comprises:
a compensation selection transistor connected between a compensation data line and the back gate of the secondary current mirror transistor and that is controlled by a compensation selection line; and
a capacitor, wherein a first terminal of the capacitor is connected at a point between the compensation selection transistor and the back gate of the secondary current mirror transistor.

3. The compensated current mirror circuit of claim 2, wherein a second terminal of the capacitor is connected to a voltage source.

4. The compensated current mirror circuit of claim 3, further comprising:
a first current-setting transistor controlled by a current selection line and connected between the primary current path and the reference current line;
a second current-setting transistor controlled by the current selection line and connected between the current mirror node and the primary current path; and
a capacitor connected at the current mirror node.

5. The compensated current mirror circuit of claim 4, further comprising:
a switch component configured to switch a load to and from the secondary current path based on one or more switch control lines.

6. The compensated current mirror circuit of claim 5, wherein the switch component is a switch transistor connected in series with the secondary current path and the load and is controlled based on the one or more switch control lines.

7. The compensated current mirror circuit of any one of claim 6, wherein the one or more switch control lines comprise a switch selection line and a switch data line and the compensated current mirror circuit further comprises:
a switch selection transistor connected between the switch data line and the switch component and that is controlled by the switch selection line; and
a capacitor, wherein a first terminal of the capacitor is connected at a point between the switch selection transistor and the switch transistor.

8. The compensated current mirror circuit of claim 5, wherein the one or more switch control lines comprise a switch selection line and a switch data line and the compensated current mirror circuit further comprises:
a switch selection transistor connected between the switch data line and the switch component and that is controlled by the switch selection line; and
a capacitor, wherein a first terminal of the capacitor is connected at a point between the switch selection transistor and the switch transistor.

9. The compensated current mirror circuit of claim 1, further comprising:
a first current-setting transistor controlled by a current selection line and connected between the primary current path and the reference current line;
a second current-setting transistor controlled by the current selection line and connected between the current mirror node and the primary current path; and
a capacitor connected at the current mirror node.

10. The compensated current mirror circuit of claim 1, further comprising:
a switch component configured to switch a load to and from the secondary current path based on one or more switch control lines.

11. The compensated current mirror circuit of claim 10, wherein the switch component is a switch transistor connected in series with the secondary current path and the load and controlled based on the one or more switch control lines.

12. A pixel circuit for driving a light-emitting diode, LED, the pixel circuit comprising the compensated current mirror circuit of claim 1, wherein the secondary current path is configured to drive the LED.

13. The pixel circuit of claim 12, wherein the LED is a PeLED, a mini-LED, or a micro-LED.

14. A system comprising:
a plurality of compensated current mirror circuits of claim 1; and
a calibration block configured to apply a compensation signal at the one or more compensation control lines.

15. The system of claim 14, wherein the calibration block is configured to apply the compensation signal for matching transistor characteristics between the primary current mirror transistor and the secondary current mirror transistor.

16. A method for controlling a compensated current mirror circuit for driving a load, the method comprising:
setting a current for driving the load by switching a reference current to a primary current path of a current mirror configured to mirror a current of the primary current path to a secondary current path; and
applying a compensation signal to a back gate of a secondary current mirror transistor of the secondary current path.

17. The method of claim 16, wherein the load corresponds to a light-emitting diode, LED.

18. The method of claim 17, further comprising:
connecting the load to the secondary current path based on a pulse-width-modulated, PWM, control signal.

19. The method of claim 16, further comprising:
connecting the load to the secondary current path based on a pulse-width-modulated, PWM, control signal.
